(19) United States
(12) Patent Application Publication
(10) Pub. No.: US 2016/0337492 A1
(43) Pub. Date: Nov. 17, 2016

(54) Cellular Phone With Built-In Selfie Stick

(71) Applicant: Chun-Lin Tseng, Taichung City (TW)

(72) Inventor: Chun-Lin Tseng, Taichung City (TW)

(21) Appl. No.: 14/710,604

(22) Filed: May 13, 2015

(51) Int. Cl. H04M 1/12

(52) U.S. Cl. CPC H04M 1/12

(57) ABSTRACT

The novel cellular phone has a built-in selfie stick extensible from the cellular phone, and an adjustable camera module is configured at a far end of the selfie stick. The cellular phone contains an accommodation chamber in a top portion of the cellular phone for housing the selfie stick. The camera module is joined to a far end of the extensible stick through a rotatable joint. The camera module is electrically connected to and controllable from the cellular phone. To use the cellular phone to take a selfie photograph, the selfie stick is pulled out of the accommodation chamber, and the image captured by the camera module is presented on a screen of the cellular phone. Due to the much reduced weight of the camera module, the camera module can be held steadily at a farther distance, and the picture taken has enhanced quality.

### BACKGROUND OF THE INVENTION

(a) Technical Field of the Invention

The present invention is generally related to cellular phones, and more particular to a cellular phone having a built-in selfie stick extensible from inside the cellular phone where a camera module is configured at a far end of the selfie stick.

(b) Description of the Prior Art

Smart phones are widely popular these days, and the smart phones' built-in photo taking capability allows people to take pictures almost anywhere and anytime. Using pictures, especially the so-called selfie pictures, to record daily activities has become a common habit to the modern people. Therefore a special kind of monopod, called selfie stick, is provided so that the smart phone can be positioned beyond the normal range of the arm, as shown in FIG. 1. The selfie stick is usually a telescopic extender with an L-shape clamp on a far end to hold the smart phone. However, the selfie stick cannot be held steadily when the smart phone is held a long distance away, and the photos taken are blurred. Additionally, some additional device is required so as to trigger the smart phone's shutter.

### SUMMARY OF THE INVENTION

Due to the above-described shortcomings of the traditional selfie sticks, the present invention provides a novel cellular phone where a selfie stick is built into and extensible from the cellular phone, and a light-weight camera module is configured at a far end of the selfie stick.

The cellular phone therefore contains an accommodation chamber in a top portion of the cellular phone for housing an extensible stick. The extensible stick is extendible from the accommodation chamber, and has a camera module joined to a far end of the extensible stick through a first rotatable joint. The camera module is electrically connected to and controllable from the cellular phone.

To use the cellular phone to take a selfie photograph, the extensible stick is pulled out of the accommodation chamber, and the image captured by the camera module is presented on a screen of the cellular phone so that a user can decide when to activate the cellular phone to take a picture. Due to the much reduced weight of the camera module, the camera module can be held steadily at a farther distance, and the picture taken is not blurred.

The cellular phone has the following advantages. Firstly, the cellular phone directly controls the remote camera module for selfie pictures without using additional devices. Secondly, only the light-weight camera module is extended on the selfie stick and it can be held steadier. The pictures taken therefore have enhanced quality. Thirdly, the selfie stick is directly pulled out the accommodation chamber to take the selfie pictures without any prior setup or configuration. Taking selfie pictures is more convenient and efficiently. Fourthly, there is no need to carry a separate selfie stick and therefore is more convenient for the user. Fifthly, the cellular phone is more appealing to the user and therefore is more competitive in the market. Sixthly, the cellular phone can be used as a document scanner or a desk lamp. Seventhly, the cellular phone can now function as a probe with a flashlight of the camera module to provide illumination.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a conventional cellular phone taking a selfie picture using a selfie stick.

FIG. 2 is a perspective diagram showing a cellular phone according to an embodiment of the present invention.

FIG. 3 is a perspective diagram showing two scenarios of the cellular phone of FIG. 2 where an extensible stick is pulled out and a camera module is positioned at different angles.

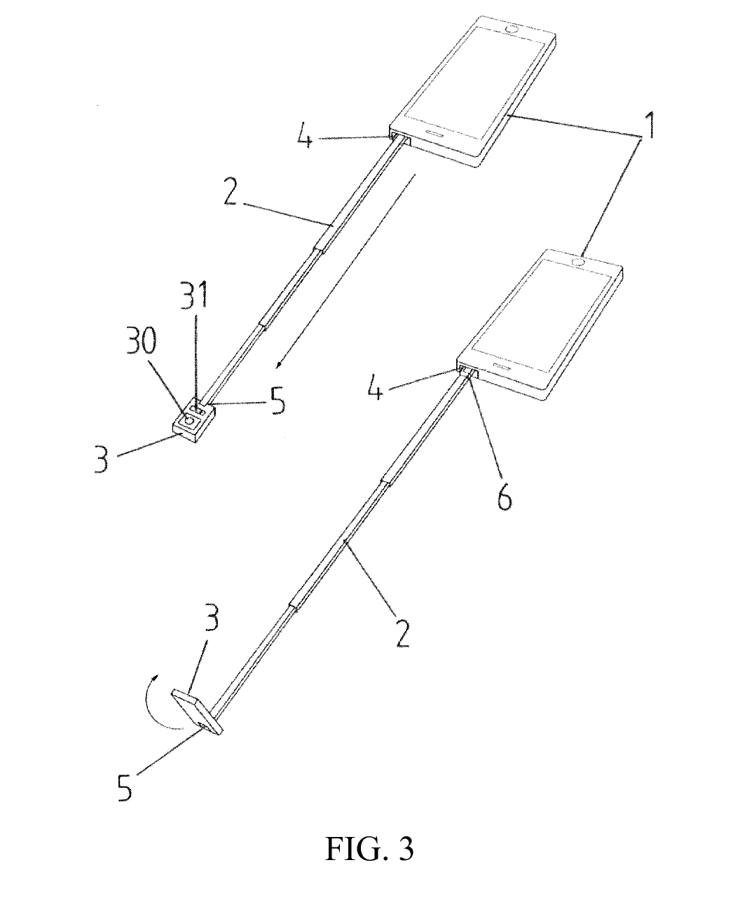

FIG. 4 is a diagram showing two scenarios of the cellular phone of FIG. 2 where an extensible stick adjusted at different angles.

FIG. 5 is a perspective diagram showing a scenario where the cellular phone of FIG. 2 is used to take a selfie picture.

FIG. 6 is a perspective diagram showing the cellular phone of FIG. 2 in a configuration for document or book scanning and illumination.

FIG. 7 is a perspective diagram showing the cellular phone of FIG. 6 used for document or book scanning and illumination.

FIG. 8 is a perspective diagram showing a scenario where the cellular phone of FIG. 2 is used as a probe.

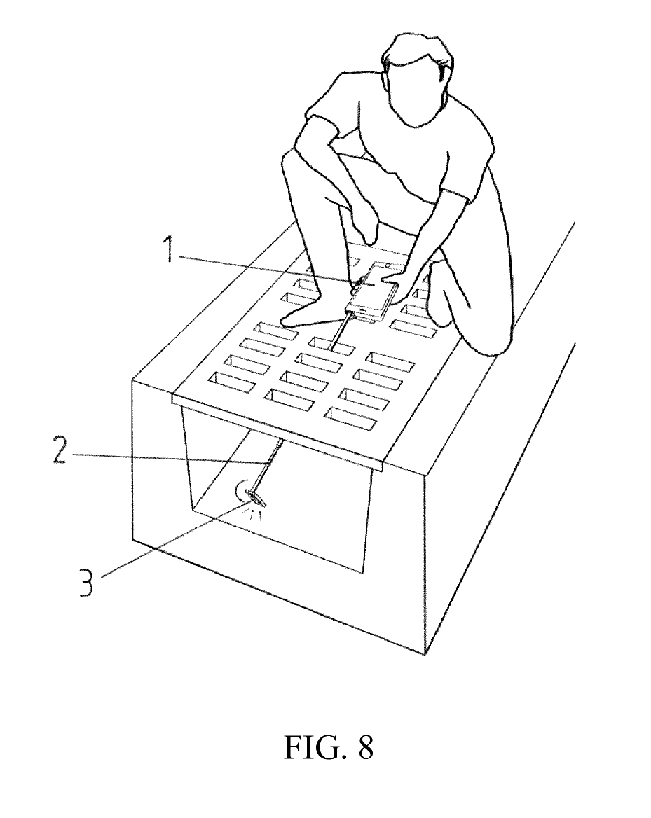

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

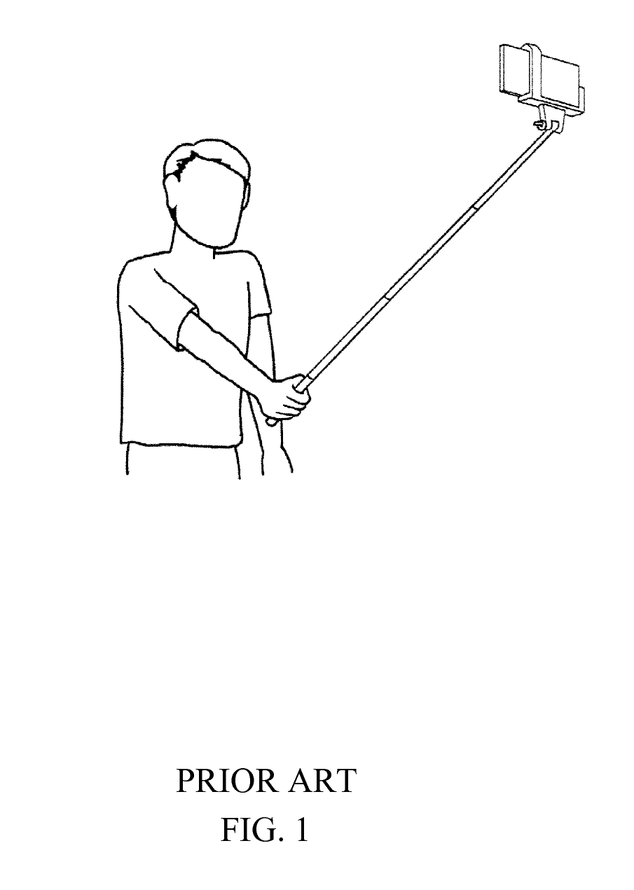

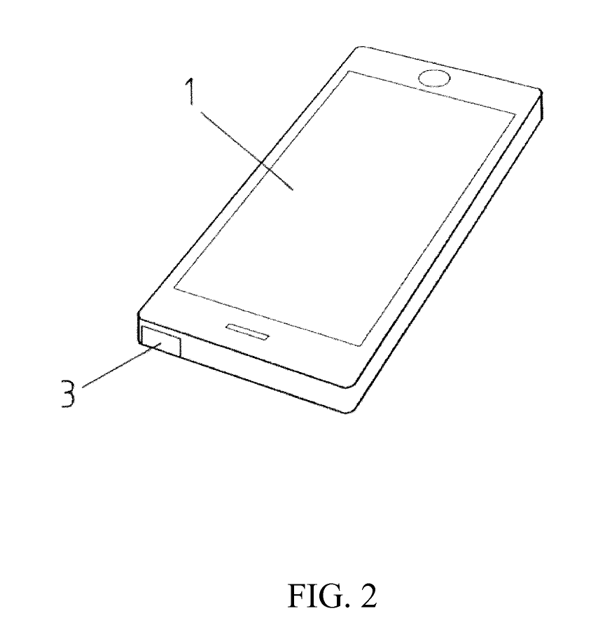

As shown in FIGS. 1 and 2, a cellular phone 1 according to an embodiment of the present invention contains an extensible stick 2 and a camera module 3 configured at a far end of the extensible stick 2. When not in used, the extensible stick 2 is retracted and concealed in an accommodation chamber 4 in a top portion of the cellular phone 1. At where the camera module 3 is joined to the extensible stick 2, a first rotatable joint 5 is configured. The camera module 3 contains a lens 30 and a flash light 31. Preferable, the first rotatable joint 5 is a universal joint. The camera module 3 is electrically connected to and controllable from the cellular phone 1.

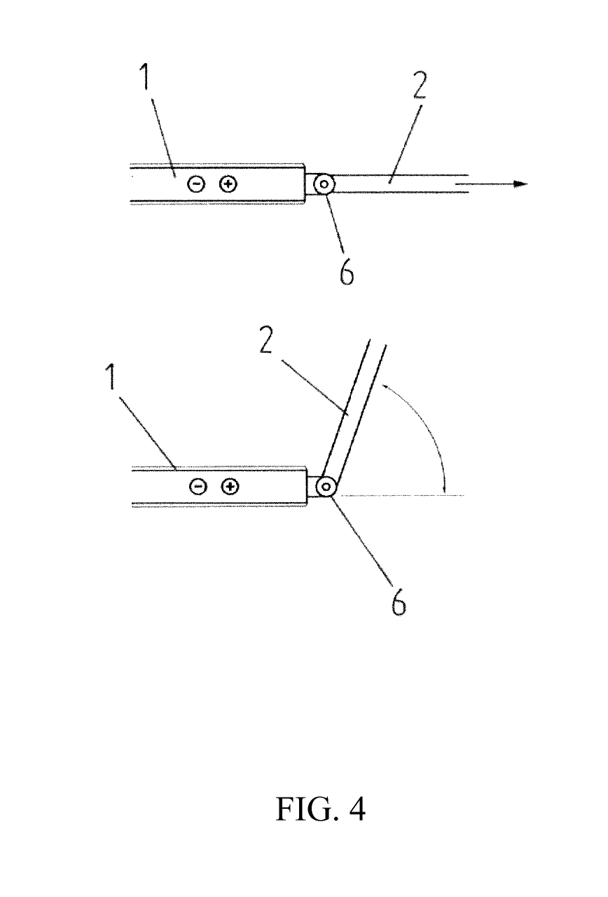

As shown in FIG. 4, the extensible stick 2 is a multi-stage telescopic extender and a second rotatable joint 6 is configured at a near end of the extensible stick 2.

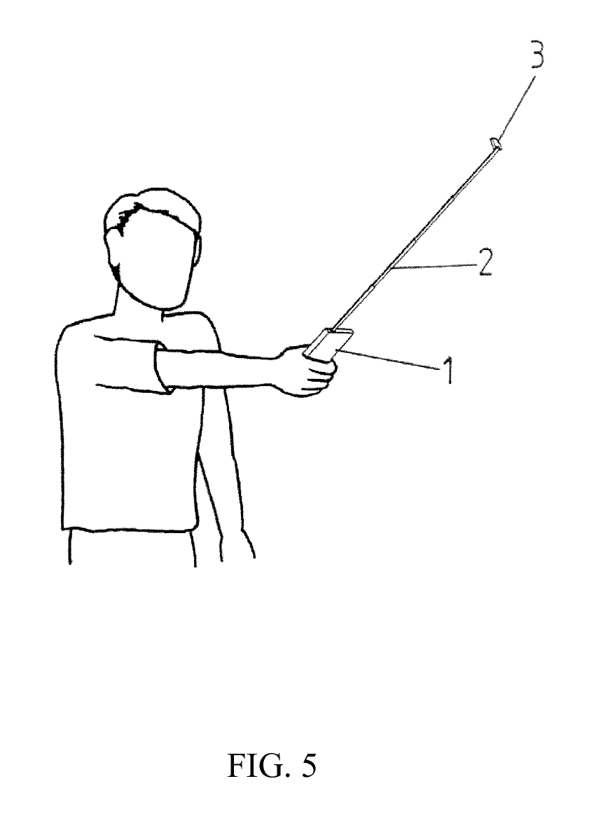

To use the cellular phone 1 to take a selfie photograph, the extensible stick 2 is pulled out of the accommodation chamber 4, and the first and second rotatable joints 5 and 6 are adjusted to appropriate angles. The image captured by the camera module 3 is presented on a screen of the cellular phone 1 and a user can decide when to activate the cellular phone 1 to take a picture, as shown in FIG. 5.

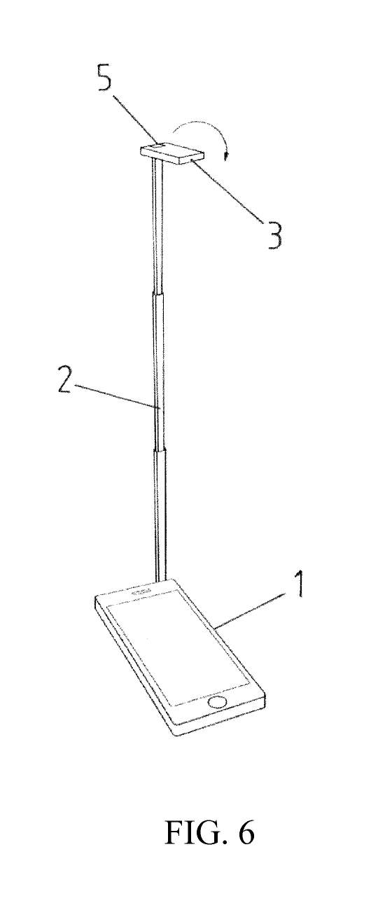

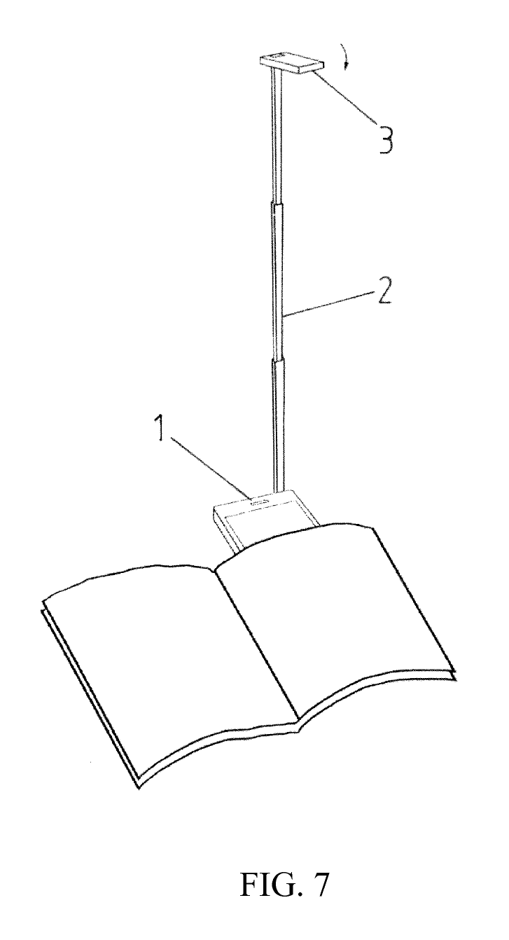

As shown in FIG. 6, the first and second rotatable joints 5 and 6 can be adjusted to form a C-like shape so that the camera module 3 faces the screen of the cellular phone 1. The cellular phone 1 then can function as a document scanner or a desk lamp as shown in FIG. 7 by using the lens 30 to take a snapshot of a document or a book, or using the flash light 31 to provide illumination to facilitate reading of the document or the book.

Additionally, as the camera module 3 can be freely extended for an appropriate distance and for an appropriate angle, the lens 30 can function as a probe to investigate some hidden place or hard-to-reach area, and the flash light 31 can provide the required illumination.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A cellular phone with built-in selfie stick, comprising:
an accommodation chamber in a top portion of the cellular phone;
an extensible stick housed in the accommodation chamber and extendible from the accommodation chamber, where the extensible stick is a telescopic extender having a first rotatable joint at a far end of the extensible stick away from the accommodation chamber and a second rotatable joint at a near end of the extensible stick adjacent to the accommodation chamber; and
a camera module rotatably joined to the far end of the extensible stick through the first rotatable joint;
wherein the camera module and the extensible stick, after the extensible stick is extended from the accommodation chamber, are rotatable at the first rotatable joint and at the second rotatable joint, respectively.

2. The cellular phone according to claim 1, wherein the camera module comprises a lens and a flash light.

3. The cellular phone according to claim 1, wherein the first rotatable joint is a universal joint.

4. (canceled)
